(19) United States
(12) Patent Application Publication
(10) Pub. No.: US 2007/0253557 A1
(43) Pub. Date: Nov. 1, 2007

(54) Methods And Apparatuses For Processing Audio Streams For Use With Multiple Devices

(76) Inventors: Xudong Song, Fremont, CA (US); Wuping Du, Santa Clara, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/458,305

(22) Filed: Jul. 18, 2006

Related U.S. Application Data
(60) Provisional application No. 60/746,149, filed on May 1, 2006.

(51) Int. Cl. H04R 29/00; H04B 1/00

(52) U.S. Cl. 381/56; 381/119

(57) ABSTRACT

The methods and apparatuses for detecting audio streams for use with multiple devices detect a sound level corresponding with each of a plurality of devices; select a selected group of devices from the plurality of devices based on the sound level corresponding with each of the plurality of devices; mix a plurality of audio streams associated with the selected group of devices and forming a mixed plurality of audio streams; and transmit the mixed plurality of audio streams to an unselected device.

### RELATED APPLICATION

The present invention is related to, and claims the benefit of U.S. Provisional Application No. 60/746,149, filed on May 1, 2006 entitled “Methods and Apparatuses For Processing Audio Streams for Use with Multiple Devices,” by Xudong Song and Wuping Du.

### FIELD OF INVENTION

The present invention relates generally to processing audio streams and, more particularly, to processing audio streams for use with multiple parties.

### BACKGROUND

There are many systems that are utilized to deliver audio signals to multiple parties. In one instance, plain old telephone service (POTS) is utilized to deliver audio signals from one party to another party. With the advent of conference calling, more than 2 parties with each party in a different location can participate in a conference call utilizing POTS. In another instance, the Internet is utilized to deliver audio signals to multiple parties. The use of the Internet for transmitting audio signals in real time between multiple parties is often referred to as voice over Internet Protocol (VoIP).

### SUMMARY

The methods and apparatuses for detecting audio streams for use with multiple devices detect a sound level corresponding with each of a plurality of devices; select a selected group of devices from the plurality of devices based on the sound level corresponding with each of the plurality of devices; mix a plurality of audio streams associated with the selected group of devices and forming a mixed plurality of audio streams; and transmit the mixed plurality of audio streams to an unselected device.

### BRIEF DESCRIPTION OF THE DRAWINGS

The accompanying drawings, which are incorporated in and constitute a part of this specification, illustrate and explain one embodiment of the methods and apparatuses for detecting audio streams for use with multiple devices.

In the drawings,

FIG. 1 is a diagram illustrating an environment within which the methods and apparatuses for detecting audio streams for use with multiple devices are implemented;

FIG. 2 is a simplified block diagram illustrating one embodiment in which the methods and apparatuses for detecting audio streams for use with multiple devices are implemented;

FIG. 3 is a simplified block diagram illustrating a system, consistent with one embodiment of the methods and apparatuses for detecting audio streams for use with multiple devices;

FIG. 4 is a simplified block diagram illustrating a system, consistent with one embodiment of the methods and apparatuses for detecting audio streams for use with multiple devices;

FIG. 5 is a functional diagram consistent with one embodiment of the methods and apparatuses for detecting audio streams for use with multiple devices; and

FIG. 6 is a functional diagram consistent with one embodiment of the methods and apparatuses for detecting audio streams for use with multiple devices.

### DETAILED DESCRIPTION

The following detailed description of the methods and apparatuses for detecting audio streams for use with multiple devices refers to the accompanying drawings. The detailed description is not intended to limit the methods and apparatuses for detecting audio streams for use with multiple devices. Instead, the scope of the methods and apparatuses for detecting audio streams for use with multiple devices is defined by the appended claims and equivalents. Those skilled in the art will recognize that many other implementations are possible, consistent with the present invention.

References to a device include a desktop computer, a portable computer, a personal digital assistant, a video phone, a landline telephone, a cellular telephone, and a device capable of receiving/transmitting an electronic signal.

References to audio signals include a digital audio signal that represents an analog audio signal and/or an analog audio signal.

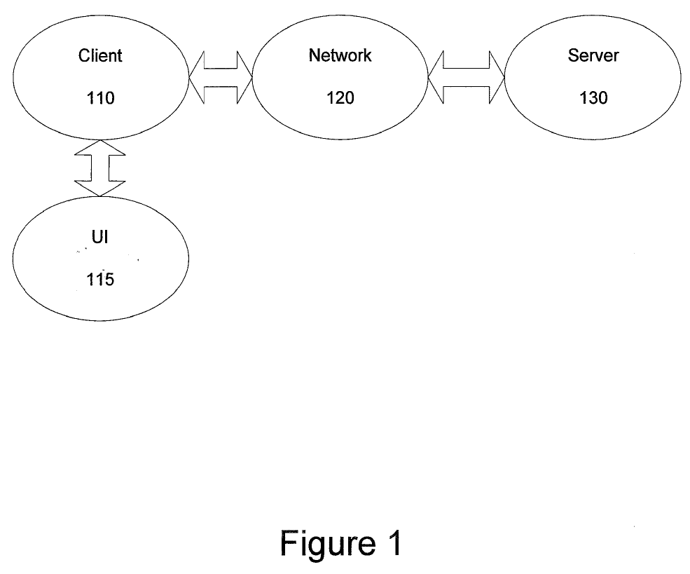

FIG. 1 is a diagram illustrating an environment within which the methods and apparatuses for detecting audio streams for use with multiple devices are implemented. The environment includes an electronic device 110 (e.g., a computing platform configured to act as a client device, such as a computer, a personal digital assistant, and the like), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing such as a personal digital assistant. In other embodiments, one or more user interface 115 components (e.g., a keyboard, a pointing device such as a mouse, a trackball, etc.), a microphone, a speaker, a display, a camera are physically separate from, and are conventionally coupled to, electronic device 110. In one embodiment, the user utilizes interface 115 to access and control content and applications stored in electronic device 110, server 130, or a remote storage device (not shown) coupled via network 120.

In accordance with the invention, embodiments of selectively controlling a remote device below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

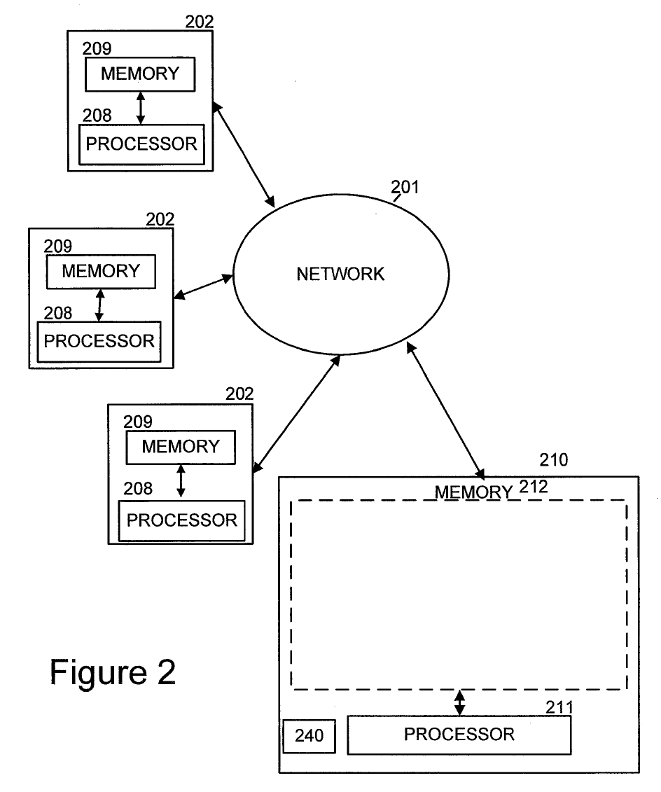

FIG. 2 is a simplified diagram illustrating an exemplary architecture in which the methods and apparatuses for detecting audio streams for use with multiple devices are implemented. The exemplary architecture includes a plurality of electronic devices 202, a server device 210, and a network 201 connecting electronic devices 202 to server 210 and each electronic device 202 to each other. The plurality of electronic devices 202 are each configured to include a computer-readable medium 209, such as random access memory, coupled to an electronic processor 208. Processor 208 executes program instructions stored in the computer-readable medium 209. In one embodiment, a unique user operates each electronic device 202 via an interface 115 as described with reference to FIG. 1.

The server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

In one embodiment, the plurality of client devices 202 and the server 210 include instructions for a customized application for detecting audio streams for use with multiple devices. In one embodiment, the plurality of computer-readable media 209 and 212 contain, in part, the customized application. Additionally, the plurality of client devices 202 and the server 210 are configured to receive and transmit electronic messages for use with the customized application. Similarly, the network 210 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on processing audio streams for use with multiple devices as determined using embodiments described below.

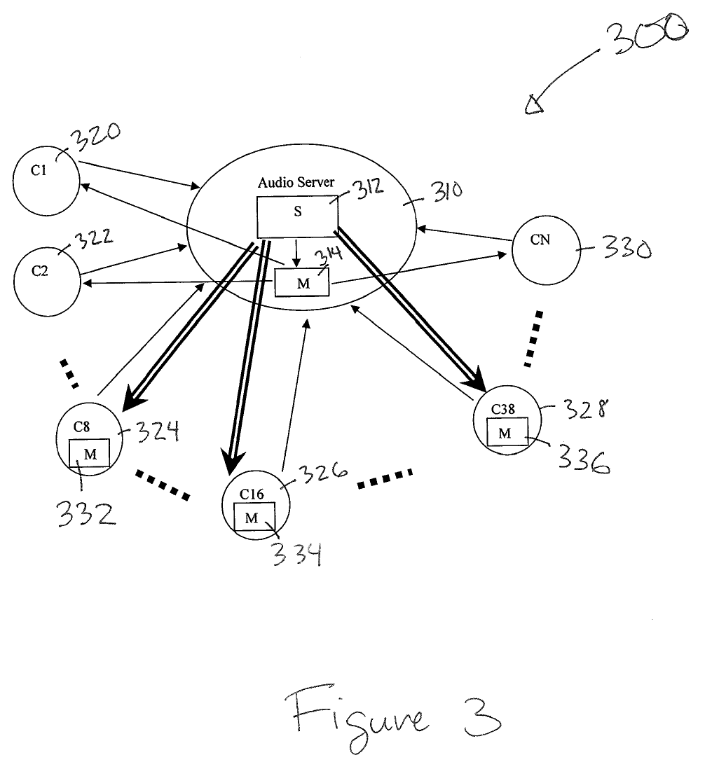

FIG. 3 is a simplified diagram illustrating an exemplary architecture in which the methods and apparatuses for detecting audio streams for use with multiple devices are implemented. In one embodiment, a system 300 includes a server 310 and devices 320, 322, 324, 326, 328, and 330. Further, each of the devices is configured to interact with the server 310. In other embodiments, any number of devices may be utilized within the system 300.

In one embodiment, the server 310 includes a selection module 312 and a mixing module 314. The selection module 312 is configured to identify the devices 320, 322, 324, 326, 328, and 330 based on the audio signals received from each respective device. Further, the mixing module 314 is configured to handle multiple streams of audio signals wherein each audio signal corresponds to a different device.

In one embodiment, the devices 324, 326, and 328 include mixing modules 332, 334, and 336, respectively. In other embodiments, any number of devices may also include a local mixing module.

In one embodiment, N audio streams can be mixed based on both server side and client side mixing through a mixing module, wherein N is equal to the number of selected devices. In one embodiment, the devices are selected through the selection module 312. In one embodiment, the server 310 facilitates audio stream transfer among the devices 320, 322, 324, 326, 328, and 330 wherein each device participates in a real-time multimedia session. In one embodiment, the server 310 receives real-time transfer protocol (RTP) streams from the selected source devices. Next, the server 310 mixes K audio streams from the selected source devices that are obtained from a selection algorithm implemented by the selection module 314 wherein K is equal to the number of selected source devices. Next, the server 310 sends the mixed audio stream to each of the unselected devices. Each selected device receives K-1 audio streams at a time wherein the K-1 audio streams represent audio streams from other selected source devices and excludes the audio stream captured on the local selected source device. Each of the selected source devices is capable of mixing and playing the K-1 audio streams.

In one example, the selection module 312 selects the devices 324, 326, and 328 as selected source devices that provide audio streams. In one embodiment, each of the devices 324, 326, and 328 also implements a voice activity detection (VAD) mechanism so that when the selected device lacks audio signals to transmit, audio packets are not transmitted from the selected device. In one instance, the lack of audio signals corresponds with a participant associated with the selected device not speaking or generating sound.

In one embodiment, mixing the audio signals is accomplished at both server 310 and among the devices 320, 322, 324, 326, 328, and 330. In another embodiment, mixing the audio signals is accomplished at the devices 320, 322, 324, 326, 328, and 330. In yet another embodiment, mixing the audio signals is accomplished at the server 310.

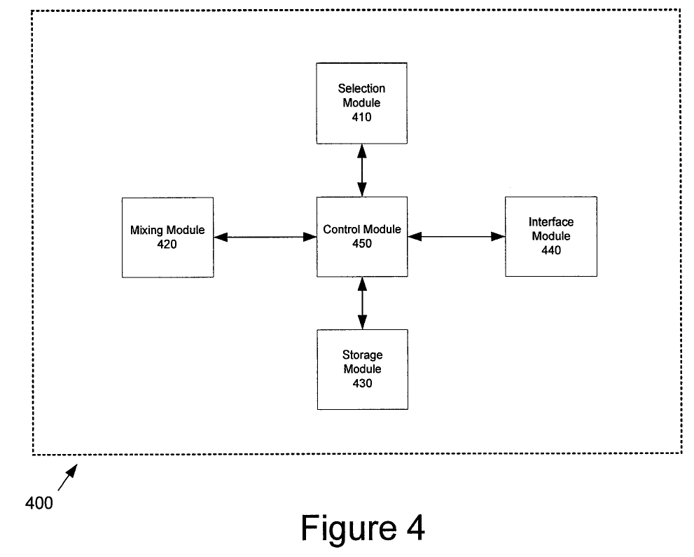

FIG. 4 illustrates one embodiment of a system 400. In one embodiment, the system 400 is embodied within the server 130. In another embodiment, the system 400 is embodied within the electronic device 110. In yet another embodiment, the system 400 is embodied within both the electronic device 110 and the server 130.

In one embodiment, the system 400 includes a selection module 410, a mixing module 420, a storage module 430, an interface module 440, and a control module 450.

In one embodiment, the control module 450 communicates with the selection module 410, the mixing module 420, the storage module 430, and the interface module 440. In one embodiment, the control module 350 coordinates tasks, requests, and communications between the selection module 410, the mixing module 420, the storage module 430, and the interface module 440.

In one embodiment, the selection module 410 determines which devices are selected to have their audio signals shared with others. In one embodiment, the audio signal for each of the devices is monitored and compared to determine which devices are selected.

In one embodiment, set {s[n]}_{n=0, . . . , N-1} be input speech signal frame and represent the audio signal from a device. The energy, E, of the current frame is computed by:

$$E = \frac{\sqrt{{\sum }_{n = 0}^{N - 1} {s}^{2} [ n ]}}{20} \qquad ( Equation 1 )$$

Each device can calculate the energy associated with each respective audio signal. In one embodiment, E1 and E2 represent the energy for two connected frames, respectively.

E=(E1+E2)/2 (Equation 2)

In one embodiment, the value E is written into a RTP header extension in two bytes.

The RTP packets from all received N audio streams can be determined to obtain an average E of the current frame for all devices.

In one embodiment, speaker activity measurement β adapts slowly such that floor allocation is graceful and allows a smooth transition. In one embodiment, β depends on E of the present and past packets. For example, β is computed within a recent past window W as follows.

$$β = \frac{1}{W} {\sum }_{t = {t}_{p}}^{{t}_{p} - W + 1} {E}_{t} . \qquad ( Equation 3 )$$

Here tₚ represents the present time. In one embodiment, W is set to 3 seconds.

In one embodiment, the β is utilized by the selection module 410 to select the devices to transmit their respective audio signals. For example, devices associated with a β that exceed a threshold are selected. In another example, devices associated with a β ranked within the top three out of all the devices are selected.

In one embodiment, K devices are selected to transmit their respective audio signals to other devices. In one embodiment, the particular K devices correspond to the largest β from all the devices. In one embodiment, the particular K devices are obtained by comparing their β values with each other. The pseudo code of this algorithm is below.

Scan the RTP packet of N audio streams to get β_{i=1, . . . , N}

Compare all the β_{i=1, . . . , N}

Select K devices number corresponding to K largest β

If (both server side and device side mixing){

Mix K selected audio streams and send the mixed audio stream to each unselected device.

}

else if (device mixing)

{

Redistribute K selected audio streams to each unselected device.

}

Except for its own audio stream, redistribute K-1 selected audio streams to each selected device.

Make sure that every participant can hear all the meaningful voices of others and can't be interrupted (smoothly switch microphone). For example (K=3), if three speakers are speaking, then they will be automatically selected as the current active speakers even if the β of the fourth speaker is larger than one of three active speakers. The fourth speaker does not join to talk until one of three speakers stop talking.

In one embodiment, the mixing module 420 is configured to selectively mix multiple audio streams into audio packets. Further, the mixing module 420 is also configured to selectively convert audio packets into an audio stream.

In one embodiment, the storage module 430 stores audio signals. In one embodiment, the audio signals are received and/or transmitted through the system 400.

In one embodiment, the interface module 440 detects audio signals from other devices and transmits audio signals to other devices. In another embodiment, the interface module 440 transmits information related to the audio signals.

The system 400 in FIG. 4 is shown for exemplary purposes and is merely one embodiment of the methods and apparatuses for detecting audio streams for use with multiple devices. Additional modules may be added to the system 400 without departing from the scope of the methods and apparatuses for detecting audio streams for use with multiple devices. Similarly, modules may be combined or deleted without departing from the scope of the methods and apparatuses for detecting audio streams for use with multiple devices.

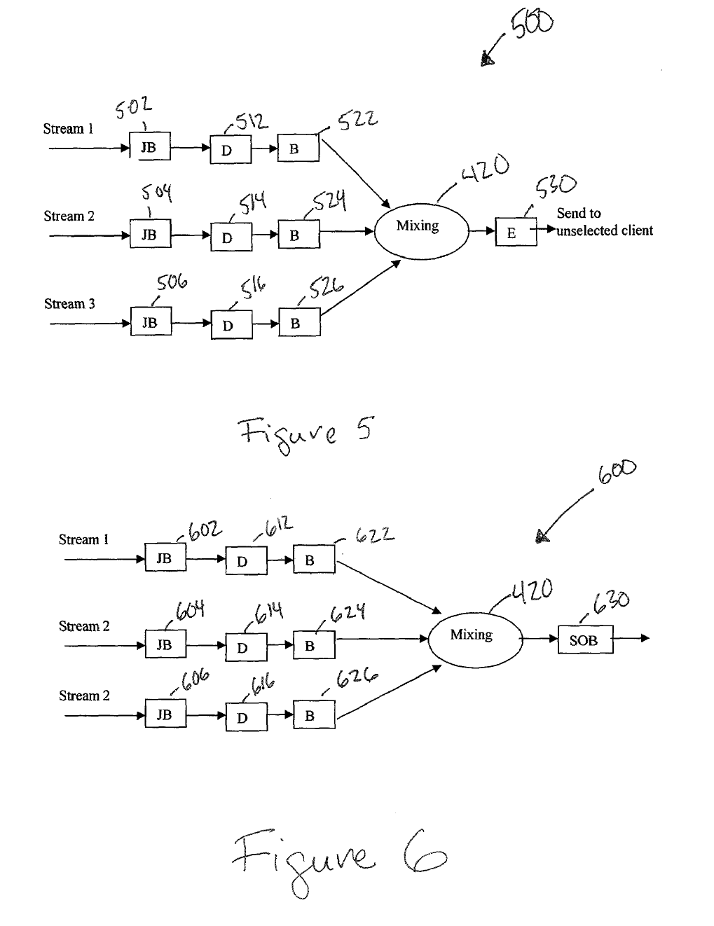

FIG. 5 illustrates mixing audio streams at the server side and/or device side mixing. In one embodiment, the audio server 312 receives audio streams from all devices 320, 322, 324, 326, 328, and 330. In one embodiment, through the selection module 410 active audio streams are selected from some of the devices 320, 322, 324, 326, 328, and 330. After the audio streams from the selected devices are mixed, the mixed audio streams are transmitted to the unselected devices.

A system 500 includes jitter buffers 502, 504, and 506; decoders 512, 514, and 516; buffers 522, 524, and 526; the mixing module 420; and encoder 530. In one embodiment, an audio packet arrives at one of the jitter buffers 502, 504, and 506 and then decoded into audio frame from one of the decoders 512, 514, and 516. In one embodiment, the decoded audio frame is appended to the participant audio buffer queue.

In one embodiment, each of the streams 1, 2, and 3 represents audio data captured from a selected device.

In one embodiment, each of the buffers 522, 524, and 526 is labeled with corresponding RTP timestamp. In one embodiment, the jitter in the audio packet arrivals is compensated by an adaptive jitter buffer algorithm. Adaptive jitter buffer algorithms work independently on each of the jitter buffers. The timer intervals that trigger mixing routines are shortened or lengthened depending on the jitter delay estimation. In one embodiment, at each frame size interval, a timer triggers a routine that mixes audio samples from appropriate input buffers into a combined audio frame. In one embodiment, this mixing occurs within the mixing module 420.

This combined audio frame is encoded using the audio encoder 530. The encoded audio data is packetized and sent to the unselected devices.

FIG. 6 illustrates mixing at a device. A system 600 includes jitter buffers 602, 604, and 606; decoders 612, 614, and 616; buffers 622, 624, and 626; the mixing module 420; and speaker output buffer 630. In one embodiment, an audio packet arrives at one of the jitter buffers 602, 604, and 606 and then decoded into audio frame from one of the decoders 612, 614, and 616. In one embodiment, the decoded audio frame is appended to the participant audio buffer queue.

In one embodiment, each of the buffers 622, 624, and 626 is labeled with corresponding RTP timestamp. In one embodiment, the jitter in the audio packet arrivals is compensated by an adaptive jitter buffer algorithm. Adaptive jitter buffer algorithms work independently on each of the jitter buffers. The timer intervals that trigger mixing routines are shortened or lengthened depending on the jitter delay estimation. In one embodiment, at each frame size interval, a timer triggers a routine that mixes audio samples from appropriate input buffers into a combined audio frame. In one embodiment, this mixing occurs within the mixing module 420.

This combined audio frame is transmitted to the speaker output buffer 630 for playback at the device.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed:

1. A method comprising:
detecting a sound level corresponding with each of a plurality of devices wherein β is utilized in detecting the sound level and defined as
$$β = \frac{1}{W} {\sum }_{t = {t}_{p}}^{{t}_{p} - W + 1} {E}_{t} ;$$
selecting a selected group of devices from the plurality of devices based on the sound level corresponding with each of the plurality of devices;
mixing a plurality of audio streams associated with the selected group of devices and forming a mixed plurality of audio streams; and
transmitting the mixed plurality of audio streams to an unselected device.

2. The method according to claim 1 further comprising comparing the sound level with a threshold level.

3. The method according to claim 2 wherein the threshold level is a predetermined level.

4. The method according to claim 1 wherein the sound level of each of the plurality of devices depends on an energy corresponding with a sound packet associated with a respective device.

5. The method according to claim 4 wherein the energy also depends on a plurality of sound packets.

6. The method according to claim 5 wherein each packet within the plurality of sound packets are temporally adjacent to each other and wherein the plurality of sound packets form a temporal window.

7. The method according to claim 1 further comprising transmitting a modified mixed plurality of audio streams to a particular one of the selected group of devices wherein the modified mixed plurality of audio streams includes the mixed plurality of audio streams with an audio stream associated except an audio stream associated with the particular selected group of devices.

8. The method according to claim 1 wherein the plurality of devices is more than two devices.

9. The method according to claim 1 wherein the plurality of devices is greater than the selected group of devices.

10. A method comprising:
identifying a plurality of devices;
monitoring a sound level for each of the plurality of devices wherein β is utilized in monitoring the sound level and defined as
$$β = \frac{1}{W} {\sum }_{t = {t}_{p}}^{{t}_{p} - W + 1} {E}_{t} ;$$
selecting a group of devices from the plurality of devices based on the sound level for each of the plurality of devices;
mixing a plurality of audio streams associated with each of the group of devices and forming a mixed plurality of audio streams; and
transmitting the mixed plurality of audio streams to a device outside of the group of devices.

11. The method according to claim 11 further comprising comparing the sound level with a threshold level.

12. The method according to claim 11 wherein the group of devices comprises a predetermined number of devices.

13. The method according to claim 11 further comprising streaming a modified mixed plurality of audio streams to a particular one of the group of devices wherein the modified mixed plurality of audio streams includes the mixed plurality of audio streams with an audio stream associated except an audio stream associated with the particular group of devices.

14. The method according to claim 11 wherein the mixing occurs at one of the group of devices.

15. The method according to claim 11 wherein the mixing occurs at a server coupled to one of the group of devices.

16. A system, comprising:
an interface module configured to monitor sound levels from a plurality of devices;
a selection module configured to select a group of devices from the plurality of devices to transmit audio signals based on the sound levels; and
a mixing module configured to mix a plurality of audio streams corresponding with the group of devices.

17. The system according to claim 16 further comprising a storage module configured to store the plurality of audio streams.

18. The system according to claim 18 wherein the interface module is further configured to transmit a mixed audio stream to a device outside of the group of devices.
